(19) United States
(12) Patent Application Publication
(10) Pub. No.: US 2009/0308132 A1
(43) Pub. Date: Dec. 17, 2009

(54) TERMINAL PLIERS

(76) Inventors: CHANG-KENG LAI, Taichung Hsien (TW); Chia-Mao Lai, Taichung Hsien (TW)

Correspondence Address: Chien-Hui Su, P. O. Box 70-121 Taichung, Taichung City, 40899, TW

(21) Appl. No.: 12/139,513

(22) Filed: Jun. 16, 2008

(51) Int. Cl. B25B 7/12; B21D 37/14

(52) U.S. Cl. 72/409.16; 81/355

(57) ABSTRACT

A terminal pliers includes a first handle pivotally and relatively connected to a second handle. The first handle has a first working end formed on one end thereof. The second handle has a second working end formed on one end thereof and facially corresponding to the first working end. The first working end and the second working end respectively have a working unit mounted thereto. Two jaws are detachably mounted to a corresponding one of the two working units. The two jaws complementally abut against each other for deforming a terminal. The two jaws are detachable and replaceable.

### BACKGROUND OF THE INVENTION

1. Field of the Invention

The present invention relates to a terminal pliers, and more particularly to a terminal pliers that has two replaceable jaws used for terminals that has different standards.

2. Description of Related Art

A conventional terminal pliers comprises a first handle pivotally connecting to a second handle. The first handle and the second handle each has a working end formed thereon. Each of the two working ends has a jaw integrally formed thereon and the two jaws are complementally connected to each other for shaping a connecting end of a wire.

However, the standards of the wires are quite a lot. For example, a flat connecting end of the wire, a thick connecting end of the wire, a narrow connecting end of the wire, a needle-like connecting end of the wire, and so on. The conventional terminal pliers only can suit for one kind connecting end of the wire. It is very un-convenient to carry different kinds of the terminal pliers for different standards of the wires.

The present invention has arisen to mitigate and/or obviate the disadvantages of the conventional terminal pliers.

### SUMMARY OF THE INVENTION

The main objective of the present invention is to provide an improved terminal pliers, which has two detachable and replaceable jaws for suiting different standards of terminals of wires.

To achieve the objective, the terminal pliers in accordance with the present invention comprises a first handle pivotally and relatively connected to a second handle. The first handle has a first working end formed on one end thereof. The second handle has a second working end formed on one end thereof and facially corresponding to the first working end. The first working end and the second working end respectively have a working unit mounted thereto. Two jaws are detachably mounted to a corresponding one of the two working units. The two jaws complementally abut against each other for deforming a terminal. The two working units respectively have a locking unit mounted thereto for holding a corresponding one of the two jaws in place. The two working units respectively have a pin extending therethrough for relatively driving the locking unit to detach the corresponding jaw. Therefore, the two jaws both are detachable and replaceable for deforming different standards of terminals of wires. It is quick to replace two new jaws by pressing the two pins and relatively compressing the locking unit for detaching the two original jaws.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a terminal pliers in accordance with the present invention;

FIG. 2 is a side plan view of the terminal pliers in FIG. 1;

FIG. 3 is an exploded perspective view of the terminal pliers in FIG. 1;

FIG. 4 and FIG. 5 are operational views of the terminal pliers in accordance with the present invention;

FIG. 6 is a cross-sectional view of the terminal pliers of the present invention along line 6-6 in FIG. 4; and

FIG. 7 is a cross-sectional view of the terminal pliers of the present invention along line 7-7 in FIG. 4.

### DETAILED DESCRIPTION OF THE INVENTION

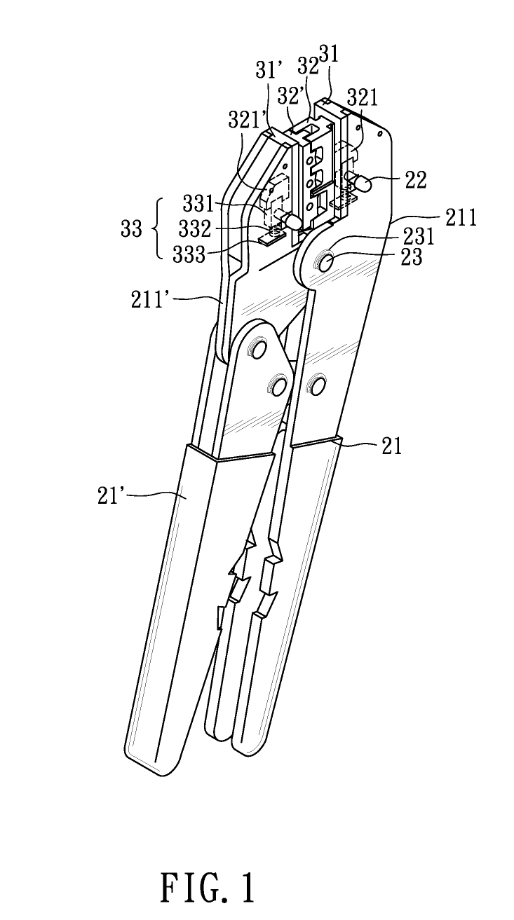

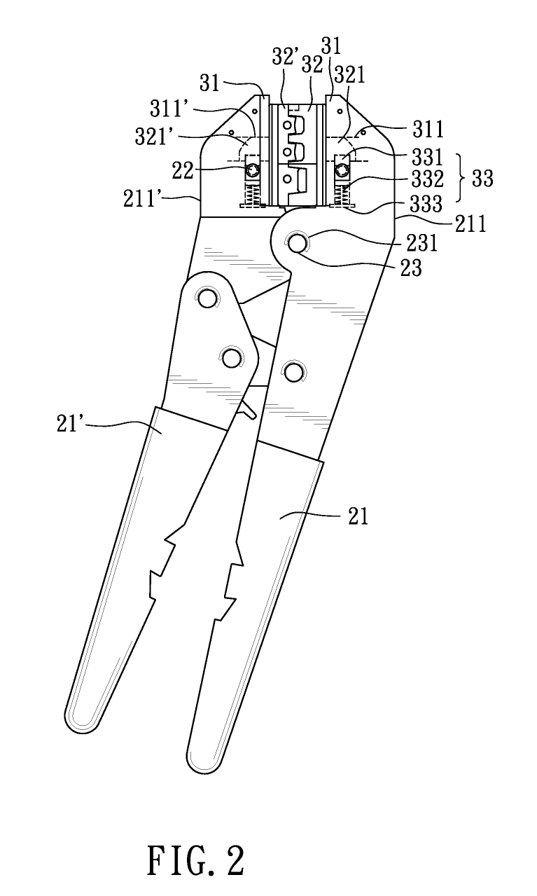

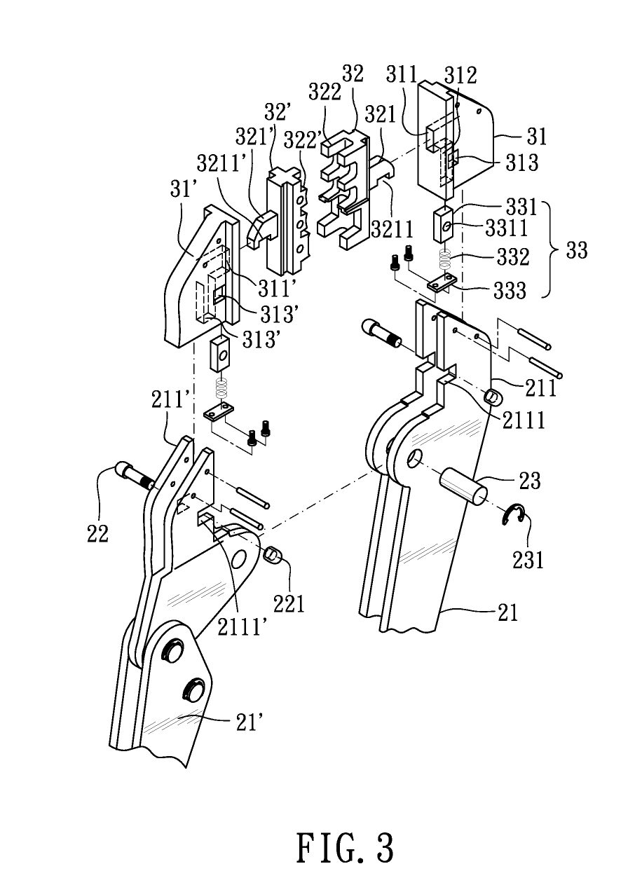

Referring to the drawings and initially to FIGS. 1-3, a terminal pliers in accordance with the present invention comprises a first handle (21) pivotally and relatively connected to a second handle (21′).

The first handle (21) has a first working end (211) formed on one end thereof and the second handle (21′) has a second working end (211′) pivotally connected to one end of the second handle (21′) and facially corresponding to the first working end (211). Each of the first working end (211) and the second working end (211′) has an indentation (2111/2111′) defined in an inner edge thereof. A shaft (23) is pivotally bolted to the first working end (211) and the second working end (211′) for pivotally connecting the first handle (21) and the second handle (21′) together. A C-shaped ring (231) is mounted to one end of the shaft (23) for preventing the shaft (23) from detaching from the terminal pliers. A first working unit (31) is securely mounted to the first working end (211) of the first handle (21) and a second working unit (31′) is securely mounted to the second working end (211) of the second handle (21′). The first working unit (31) is formed with a working surface. A slot (311) is laterally defined in the first working unit (31) and extends to the working surface of the first working unit (31). A sliding groove (312) is defined in the first working unit (31), extends to a lower end of the first working unit (31) and communicates with the slot (311). A through aperture (313) is laterally defined in the first working unit (311) and laterally communicates with the sliding groove (312) and the indentation (2111). The second working unit (31′) has a structure symmetrically corresponding to that of the first working unit (31). Consequently, the second working unit (31′) includes a working surface facing the working surface of the first working unit (31), and a slot (311′), a sliding groove (312′) and a through aperture (313′) respectively defined in the second working unit (31′). The first working unit (31) and the second working unit (31′) respectively has a locking unit (33) mounted thereto. The locking unit (33) includes a locking member (331) reciprocally slidably mounted in the sliding groove (312/312′) and an elastic member (332) compressively received in the sliding groove (312/312′). A plate (333) is secured to the lower end of the first working unit (31)/the second working unit (31′) to prevent the locking member (331) and the elastic member (332) from detaching from the first working unit (31)/the second working unit (31′). The locking member (331) has a hole (3311) laterally defined therein and extending therethrough. The hole (3311) communicates with the through aperture (313/313′). Each of the first working end (211) and the second working end (211′) has a pin (22) sequentially laterally extending through the indentation (2111/211′), the through aperture (313/313′) and the sliding groove (312/312′) for driving the locking member (331) in the first working unit (31)/the second working unit (31′). A cap (221) is mounted to one end of the pin (22) for preventing the pin (22) from detaching from the terminal pliers. A first jaw (32) and a second jaw (32′) respectively mounted to the first working unit (31) and the second working unit (31′). The first jaw (32) has a protrusion (321) extending therefrom and received in the slot (311). The protrusion (321) has a recess (3211) defined therein for selectively and partially receiving the locking member (331) and preventing the first jaw (32) from detaching from the first working unit (31) when the protrusion (321) inserted into the slot (311). The first jaw (32) has a first series of teeth (322) formed thereon opposite to the working surface of the first working unit (31). The second jaw (32′) has a protrusion (321′) extending therefrom and received in the slot (311′). The protrusion (321′) has a recess (3211′) defined therein for selectively and partially receiving the locking member (331) in the second working unit (31′) and preventing the second jaw (32′) from detaching from the second working unit (31′) when the protrusion (321′) inserted into the slot (311′) in the second working unit (31′). The second jaw (32′) has a series of second teeth (322′) formed thereon opposite to the working surface of the second working unit (31′). The series of first teeth (322) and the series of second teeth (322′) forcefully and complementally abut against each other for deforming a terminal to be securely connected with one or more wire when the first handle (21) and the second handle (21′) are operated and approached to each other.

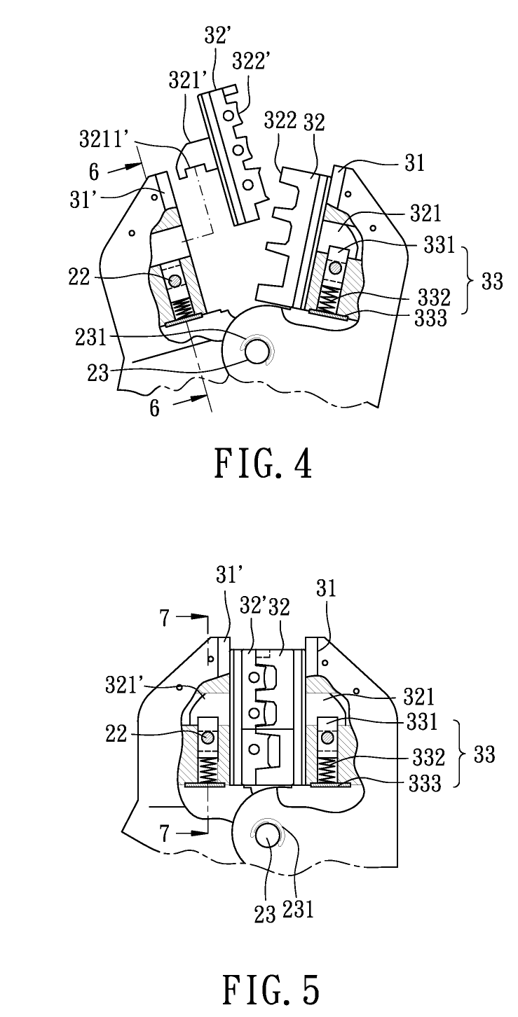

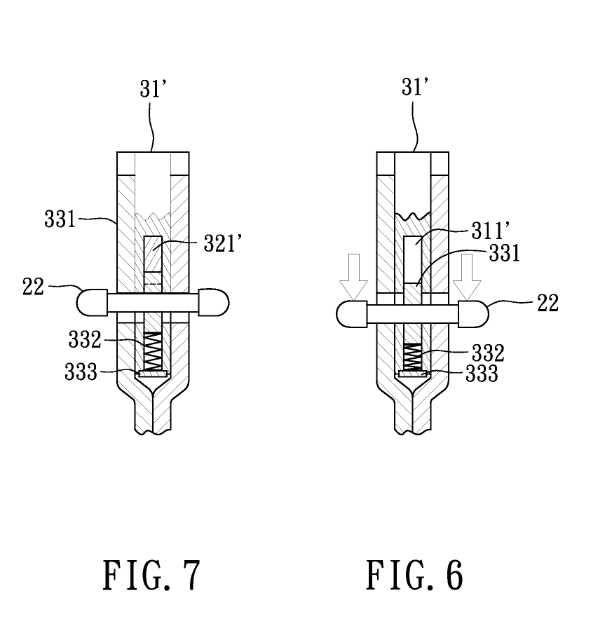

With reference to FIG. 4 to FIG. 8 that show the protrusion (321′) of the second jaw (32′) is inserted into the slot (311′) of the second working unit (31′) when the pin (22) disposed in the second working unit (31′) is downwardly pressed for relatively compressing the elastic member (332) of the locking unit (33) to drive the locking member (331) slidably detached from the slot (331) along the sliding groove (312′). After the protrusion (321′) of the second jaw (32′) is integrally received in the slot (311′) of the second working unit (31′), the second jaw (32′) is locked when the pin (22) is upwardly released and the locking member (331) is relatively and slidably received in the recess (3211′) of the protrusion (321′) of the second jaw (32′) due to a restriction force of the elastic member (332′) of the locking unit (33). Consequently, the first jaw (32) is also detachable due to the first working unit (31) having a structure symmetrically corresponding to that of the second working unit (31′). Therefore, the first jaw (32) and the second jaw (32′) both are detachable to respectively replace another/a new first jaw having a different standard of series of first teeth and another/a new second jaw having a series of second teeth corresponding to the first teeth for deforming different standards of terminals of wire.

Although the invention has been explained in relation to its preferred embodiment, it is to be understood that many other possible modifications and variations can be made without departing from the spirit and scope of the invention as hereinafter claimed.

What is claimed is:

1. A terminal pliers comprising:
a first handle pivotally and relatively connected to a second handle, the first handle having a first working end formed on one end thereof, the second handle having a second working end formed on one end thereof and facially corresponding to the first working end, the first working end and the second working end respectively having a working unit mounted thereto; and
two jaws detachably mounted to a corresponding one of the two working units, the two jaws complementally abutting against each other for deforming a terminal, the two jaws being detachable and replaceable.

2. The terminal pliers as claimed in claim 1, wherein the two working units respectively have a locking unit mounted thereto for holding a corresponding one of the two jaws in place, the two working units respectively having a pin extending therethrough for relatively driving the locking unit to detach the corresponding jaw.

3. The terminal pliers as claimed in claim 2, wherein each of the two working unit includes:
a slot laterally defined therein for partially receiving the corresponding jaw;
a sliding groove defined therein and communicate with the slot; and
a through aperture laterally defined therein and laterally communicating with the sliding groove to allow the pin extending therethrough.

4. The terminal pliers as claimed in claim 3, wherein the locking unit includes:
a locking member reciprocally sildably mounted in the sliding groove;
an elastic member compressively received in the sliding groove; and
a plate secured to a lower end of the corresponding working unit to prevent the locking member and the elastic member from detaching from the corresponding working unit.

5. The terminal pliers as claimed in claim 3, wherein each of the two jaws has a protrusion extending therefrom and detachably received in the slot, a recess defined in the protrusion for receiving the locking member to prevent the correspond jaw from detaching from the corresponding working units.

6. The terminal pliers as claimed in claim 1, wherein each of the two jaws has a series of teeth formed thereon for forcefully and complementally abutting against each other for deforming a terminal.
